(19) United States
(12) Patent Application Publication
(10) Pub. No.: US 2025/0227078 A1
(43) Pub. Date: Jul. 10, 2025

(54) PERSONALIZING INTERACTIVE AGENTS FOR CONVERSATIONAL AI SYSTEMS AND APPLICATIONS

(71) Applicant: NVIDIA Corporation, Santa Clara, CA (US)

(72) Inventors: Yi DONG, Lexington, MA (US); Xianchao WU, Tokyo (JP)

(73) Assignee: NVIDIA Corporation, Santa Clara, CA (US)

(21) Appl. No.: 18/409,048

(22) Filed: Jan. 10, 2024

(51) Int. Cl. H04L 51/02; G06F 40/40; H04L 51/216

(52) U.S. Cl. CPC H04L 51/02; G06F 40/40; H04L 51/216

(57) ABSTRACT

In various examples, systems and methods are disclosed relating to engaging users through a personalized interface. One system includes at least one processor configured to determine first conversation history with a user. The at least one processor further configured to determine a response by applying the first conversation history with the user to a machine learning model, wherein the machine learning model is updated using user input indicative of an interest level of the user for each of a plurality of candidate responses to a question, a content of the question is determined by the at least one processor, and the plurality of candidate responses are determined using the machine learning model, and the machine learning model is updated using the user input as a reward signal.

### BACKGROUND

As interactive artificial intelligence (AI) advances, along with growing user expectations, there is a need to enhance the engagement of users with the interactive AIs. This includes reducing the statelessness of the interactive AIs and increasing user engagement. Traditional techniques employed in interactive AIs often present challenges related to engagement.

### SUMMARY

Some embodiments relate to a system including at least one processor to determine first conversation history with a user and determine a response by applying the first conversation history with the user to a machine learning model, wherein the machine learning model is updated using user input indicative of an interest level of the user for each of a plurality of candidate responses to a question, a content of the question is determined by the at least one processor, and the plurality of candidate responses are determined by the machine learning model, and the machine learning model is updated using the user input as a reward signal.

In some embodiments, the at least one processor is configured to determine the plurality of candidate responses using second conversation history with the user and user data of the user.

In some embodiments, the machine learning model includes at least one encoder, a base policy network, and a personalization network, the at least one encoder to determine at least one vector representation of user data of the user by encoding user data, the personalization network to determine at least one weight by inputting the at least one vector representation into the personalization network, the at least one weight is applied to the base policy network.

In some embodiments, the base policy network and the personalization network are updated using proximal policy optimization to maximize the reward signal and the machine learning model, using a Neural Hawkes Process (NHP) statistical model, analyzes temporal dynamics in user engagement for the determination of the at least one weight.

In some embodiments, the personalization network employs a Multilayer Perceptron (MLP) network to generate a plurality of weights based on user data and the plurality of weights are applied to the base policy network to personalize responses.

In some embodiments, the machine learning model is a large language model (LLM), and wherein the machine learning model is updated using reinforcement learning from human feedback (RLHF).

In some embodiments, the at least one processor is included in at least one of a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing large language models (LLMs), a system for hosting one or more real-time streaming applications, a system for performing light transport simulation, a system for performing collaborative content creation for 3D assets, or a system implemented at least partially using cloud computing resources.

In some embodiments, the user input includes a first user input indicating positive interest and a second user input indicating negative interest.

In some embodiments, the machine learning model includes a base policy network, the at least one processor updates the base policy network using a reward function, the at least one processor applies the user input as the reward signal to the reward function and updating the machine learning model includes maximizing an expected reward for the base policy network.

Some embodiments relate to a system including at least one processor to cause a user interface to display a question and a plurality of candidate responses to the question, wherein a content of the question is determined by the at least one processor, determine user input of a user via the user interface, the user input indicative of an interest level of the user for each of the plurality of candidate responses, and update a machine learning model using the user input as a reward signal.

In some embodiments, the machine learning model determines the plurality of candidate responses using conversation history with the user and user data of the user.

In some embodiments, the question and the plurality of candidate responses are displayed simultaneously in a same screen of the user interface.

In some embodiments, the machine learning model includes at least one encoder, a base policy network, and a personalization network, the at least one encoder to determine at least one vector representation of user data of the user by encoding the user data, the personalization network to determine at least one weight by inputting the at least one vector representation into the personalization network, and the at least one weight is applied to the base policy network.

In some embodiments, the base policy network and the personalization network are updated using proximal policy optimization to maximize the reward signal and the machine learning model, using a Neural Hawkes Process (NHP) statistical model, analyzes temporal dynamics in user engagement for the determination of the at least one weight.

In some embodiments, the personalization network employs a Multilayer Perceptron (MLP) network to generate a plurality of weights based on user data and the plurality of weights are applied to the base policy network to personalize responses.

Some embodiments relate to a method, including determining, by one or more processing circuits, conversation history with a user and determining, by the one or more processing circuits, a response by applying the conversation history with the user to a machine learning model, wherein the machine learning model is updated using user input indicative of an interest level of the user for each of a plurality of candidate responses to a question.

In some embodiments, the plurality of candidate responses are determined using second conversation history with the user and user data of the user.

In some embodiments, the method further includes determining, by the one or more processing circuits, at least one vector representation of user data of the user by encoding user data, determining, by the one or more processing circuits, at least one weight by inputting the at least one vector representation into a personalization network, and applying, by the one or more processing circuits, the at least one weight is to a base policy network.

In some embodiments, the base policy network and the personalization network are updated using proximal policy optimization to maximize a reward signal and the one or more processing circuits executing the machine learning model, using a Neural Hawkes Process (NHP) statistical model, analyzes temporal dynamics in user engagement for the determination of the at least one weight.

In some embodiments, the method further includes generating, by the one or more processing circuits, a plurality of weights based on user data using a Multilayer Perceptron (MLP) network.

### BRIEF DESCRIPTION OF THE DRAWINGS

The present systems and methods for personalized conversation agents are described in detail below with reference to the attached drawing figures, wherein:

FIG. 1 is a block diagram of an example system that implements personalized conversational agents for increasing user engagement, in accordance with some embodiments of the present disclosure;

FIG. 2 is a block diagram depicting a hierarchical personalized policy network and architecture, in accordance with some embodiments of the present disclosure;

FIG. 3 is a flow diagram of an example of a method for personalizing and training a conversational agent and improving user engagement, in accordance with some embodiments of the present disclosure;

FIGS. 4A-4C depict example conversations with the personalized conversation agent described in FIGS. 1-3, in accordance with some embodiments of the present disclosure;

FIG. 5 depicts an example event stream related to user interest and engagement, in accordance with some embodiments of the present disclosure;

FIG. 6 is a block diagram of an example content streaming system suitable for use in implementing some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

Current virtual assistants developed using large language models (LLMs) are passive and do not actively engage the user. Without the capability to collect user engagement data, a conventional user interface allows a virtual assistant to only respond to user instructions or questions without actively initiating engagement. Furthermore, conventional training methods such as reinforcement learning from human feedback (RLHF) focus on aligning the virtual assistant with general human preferences rather than personalizing the virtual assistant for individual differences. As a result, user engagement with virtual assistants remains low despite continued advancement in LLMs underpinning the virtual assistants. Current virtual assistants operate statelessly, without considering user interests evolution over time.

The embodiments disclosed herein relate to virtual assistants configured to understand changes of users' interests over time based on interactions between the users and the virtual assistants to enable the virtual assistants to provide timely and relevant recommendations tailored to current interests of users. For example, a virtual assistant can generate responses tailored to a user's unique interests and personality, instead of based solely on generic preferences of the population at large. As a result, the virtual assistants are proactive in the conversation with the users instead of passively responding.

In some embodiments, a virtual assistant has a conversational user interface that allows the virtual assistant to initiate dialog with a user and collects explicit user engagement data on the user's responses. An engagement-focused RLHF method can be implemented to use the user engagement data as input to align the virtual assistant to maximize user engagement. The user's interests can be modeled as a function of time using Neural Hawke Processes, where the shifts in user interests can be identified using such a function. The responses of the virtual assistant can be customized using individual user data.

In some examples, to provide direct optimization for user engagement, a user interface of a virtual assistant can present multiple candidate responses to a question, and receive user engagement data in the form of user input indicative of the interest of the user for each of the multiple candidate responses. The RLHF method can use the user engagement data of the particular user as reward signals instead of generic human preferences across multiple different users. Thus, the reward model can explicitly model the user interest dynamics. The personalization and customization can be used to adjust the policy network for each user using the user engagement data to capture individual differences in user interests across different users.

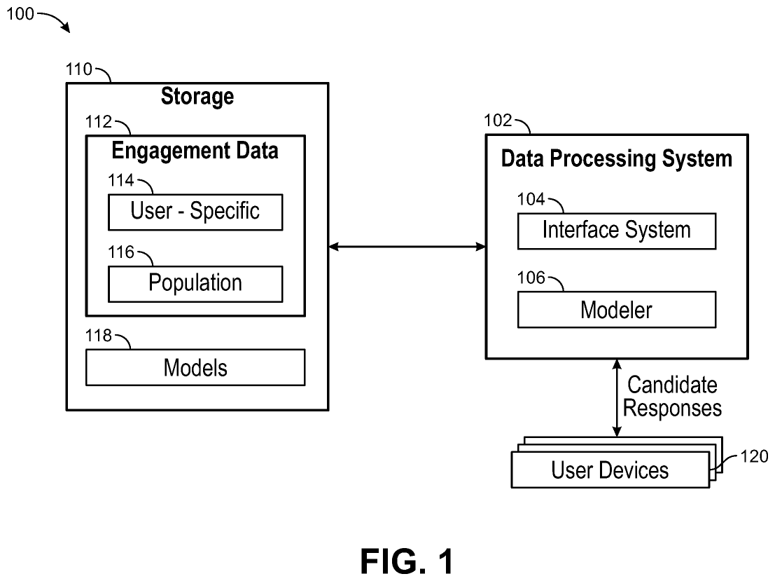

Referring now to FIG. 1, a block diagram of an example system 100 that implements personalized conversational agents for increasing user engagement, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine-learning model), operation, routine, logic, or instructions to perform functions such as determining responses or training/updating and/or executing models as described herein.

The system 100 is shown as including the data processing system 102 and the storage 110. The data processing system 102 can access the storage 110 to retrieve and store engagement data 112, in particular, user-specific engagement data 114 and population engagement data 116, which may be used to generate and train models, such as stored models 118, and/or provide responses via an interface. The storage 110 may be an external server, distributed storage/computing environment (e.g., a cloud storage system), or any other type of storage device or system that is in communication with the data processing system 102. Although shown as external to the data processing system 102, it should be understood that the storage 110 may form a part of, or may otherwise be internal to, the data processing system 102.

In general, the data processing system 102 relates to an active interactive system or agent that can initiate and conduct communications with user devices 120. In many systems, interactive systems are passive and fail to engage the user. For example, typical user interfaces only allow the assistant to respond to user instructions without initiating engagement. Furthermore, existing methods like reinforcement learning from human feedback (RLHF) focus on aligning the assistant with general human preferences rather than personalizing for individual differences Specifically, RLHFs, while effective in aligning virtual assistants with broad human preferences, lack the capability to personalize interactions based on individual user differences. This one-size-fits-all approach often leads to a disconnect between the assistant's recommendations and the user's actual needs or interests, resulting in lower user engagement.

To address this, the data processing system 102 implements a more dynamic and personalized interactive system. Instead, the data processing system 102 can operate in a stateful manner, where the interactions with users not only respond to immediate queries but also learn and adapt based on the user's evolving interests over time. To implement the dynamic and personalized interactive systems, the data processing system 102 can implement, train, and deploy models that understand the user's interaction history, preferences, and behavioral patterns (e.g., stored in user-specific engagement data 114).

In some embodiments, the modeler 106 of the data processing system 102 can be configured to implement and integrate various machine learning techniques that analyze and predict individual user behavior. For example, the predictions can be based on tracking the types of queries a user makes, the content they prefer, and how their interests shift over time. By leveraging this data, the assistant provided by interface system 104 can provide more accurate, timely, and relevant recommendations or responses. For example, if a user frequently asks about new science fiction books, the modeler 106 could learn to anticipate this interest and proactively suggest new releases in this genre. Similarly, if a user's interest shifts from one topic to another, the modeler 106 would gradually adjust its recommendations to align with these new interests. Accordingly, incorporating a personalized and adaptive architecture significantly improves the user experience, making virtual assistants and interactive systems generally more than just tools for information retrieval, but rather, intelligent companions that understand and grow with the user. Specifically, this personalized and adaptive architecture would increase user engagement and establish models for more nuanced and sophisticated human-computer interactions.

Referring specifically now to the modeler 106 of data processing system 102, the circuit (or system) is designed and configured to model the user's interest shifts as a function of time via neural network-based temporal point process models. For example, the neural network-based temporal point process models could be, but is not limited to, one or more of a Neural Hawkes Process, Recurrent Neural Networks (RNNs) for time series, Long Short-Term Memory (LSTM) networks, Continuous-Time Recurrent Neural Networks (CTRNNs), Hidden Markov Models (HMMs), Gaussian Process-based models, and/or Autoregressive Integrated Moving Average (ARIMA) models. In some embodiments, modeling the user can include training a language model policy network (hereafter referred to as the “policy network”) according to a hierarchical architecture that leverages the user-specific engagement data 114 collected through the conversational interface provided by interface system 104 and/or user device data of user device 120. In some embodiments, a model using a Neural Hawkes Process can be trained and used model user's interest shifts as a function of time, since user interests can often be dynamic over time. In particular, the model can better understand the user's interest shifts through the user's past events. For example, the model can be trained and used to determine what events excite or suppress future interests.

Specifically, the model trained using a Neural Hawkes Process can capture the temporal dynamics of user interactions. By analyzing the sequence and timing of past events, such as user queries or actions (generally referred to as engagements), the model can predict how these events influence future interests. In some embodiments, the model trained using a Neural Hawkes Process can model the intensity function of events over time, allowing the modeler 106 to discern patterns and trends in user behavior that may not be immediately apparent. This model, when integrated with the data processing system 102, specifically the personalized GUI of interface system 104, enables the assistant to anticipate changes in user interests, enhancing the relevance and timing of its responses and recommendations. Additionally, the modeler 106 can continuously learn and adapt from user engagements, thereby refining its understanding of the user's evolving preferences and interests. As a result, the assistant provided by the interface system 104 becomes an active assistant, providing personalized and engaging user experiences.

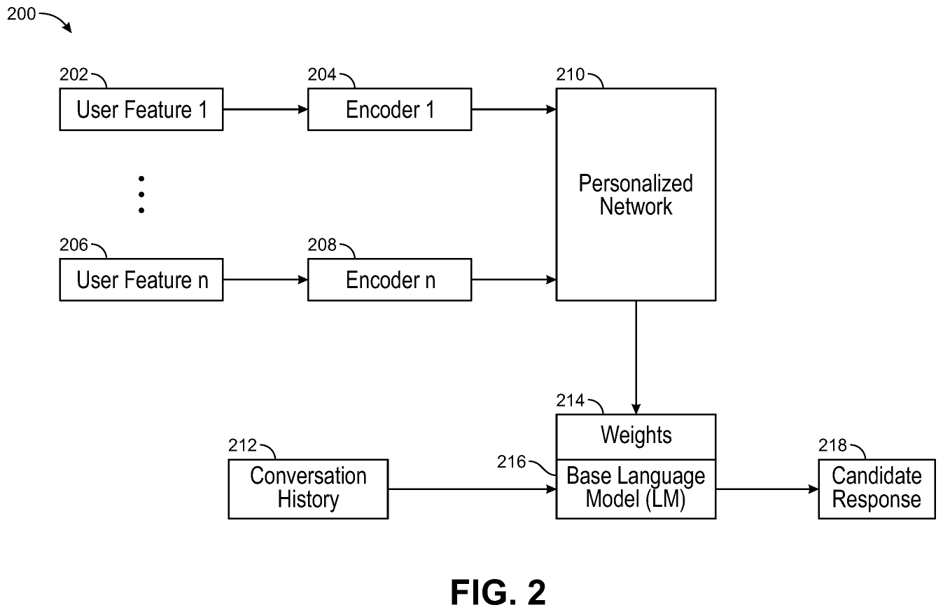

In some embodiments, the policy network is a type of machine learning model that can be specifically designed to understand, generate, and interpret human language. The training process can include feeding the model large amounts of text data (e.g., user-specific engagement data 114 and/or population engagement data 116) so that the modeler 106 can train the policy network using the patterns, structures, and nuances of the language. The policy network can have a series of weights and parameters within a neural network architecture. These weights can be adjusted during the training process by modeler 106 to capture the intricacies of human language and user engagements. Additionally, information about training the policy network is described in greater detail with reference to FIG. 2.

The modeler 106 is further configured to use an engagement-focused reinforcement learning from human feedback (RLHF) method to re-train the policy network and align the assistant (e.g., stored in models 118 of storage 110) to increase user engagement using the collected data (e.g., engagement data 112 of storage 110). In some embodiments, RLHF method implemented by the modeler 106 can use engagement as the reward signal instead of generic human preferences. Accordingly, the policy network can focus the alignment on engagement maximization. This approach allows for a more dynamic and responsive adaptation of the policy network to the evolving interests and preferences of the users. By prioritizing user engagement as the key metric for success, the modeler 106 ensures that the assistant's responses and recommendations are continually refined to maintain relevance and effectiveness. The continuous re-training process, facilitated by the RLHF method, leverages the latest engagement data to adjust the model's parameters. This ensures that the assistant responds accurately to user queries and also proactively anticipates user needs and preferences. In some embodiments, the reward signal includes preference-based metrics and user engagement metrics, creating a feedback loop.

The modeler 106 can further be configured to implement a personalization component that customizes the assistant's responses based on individual user data (e.g., user-specific engagement data 114 of storage 110). For example, the interface system 104 can elicit explicit engagement data by presenting multiple candidate responses and having users indicate an interest. The indication of an interest between two or more candidate responses can be used by modeler 106 to train a user-specific policy network.

In some embodiments, the training of the personalized policy network by modeler 106 is carried out through an engagement-focused Reinforcement Learning from Human Feedback (RLHF) approach. The modeler 106 can train multiple value models within this framework. The conversational interface provided by the interface system 104 can collect the explicit user engagement data for each candidate response. This engagement data (e.g., stored in user-specific engagement data 114) can be used as a reward signal for training the policy network, employing techniques such as proximal policy optimization (PPO) with an engagement-oriented reward function. For example, each candidate response generated by the policy network can be considered an action. A reward of +1 can be assigned for responses that successfully capture the user's interest, leading to further engagement. Conversely, responses that do not elicit user interaction can receive a 0 reward. Thus, the modeler 106 can refine the policy network to maximize the expected engagement reward over time.

In some embodiments, the PPO algorithm's loss function includes a Kullback-Leibler (KL) divergence penalty term. This term can act as a constraint, ensuring that the updated policy network does not stray too far from the original policy network. This regulatory measure can be used to maintain stability in the learning process, preventing the policy network from overfitting to anomalies or biases in the engagement data. Furthermore, beyond relying on engagement data, other RLHF preference rewards can also be integrated. For example, the modeler 106 can use human ratings or rankings of the quality of responses as additional reward signals. In some embodiments, the modeler 106 can combine the objectives of optimizing for user engagement while also ensuring the generation of high-quality responses. Accordingly, the end-to-end RLHF approach, specifically tuned for user engagement, is designed to direct the assistant's behavior towards maximizing user interest. Specifically, the interface system 104 can obtain more meaningful and sustained conversations, enhancing the overall effectiveness of the assistant. Additionally, by continuously updating the policy network with the feedback signals, the modeler 106 ensures that the assistant remains adaptive and responsive to user preferences.

Referring specifically now to the interface system 104 of data processing system 102, the circuit (or system) is designed and configured to implement a conversational interface that allows assistants to initiate dialog and collects explicit user engagement data on responses. In some embodiments, the interface system 104 can generate and present a personalized graphical user interface (GUI) corresponding with a personalized assistant on user device(s) 120. The user device 120 can interact with (e.g., provide input such as responses or prompts, etc., to) the personalized GUI. In some embodiments, the interface system 104 can collect engagement data from the personalized GUI, as well as other interactions by the user with their user device 120.

In some embodiments, the personalized GUI can provide an assistant integrated with a model (e.g., neural network-based temporal point process models), such as a model generated and trained by modeler 106 and stored in models 118 of storage 110. Additionally, the engagement data can be collected or received via the personalized GUI. In general, the interactions between the assistant provided in the personalized GUI and the policy networks (e.g., trained and implemented by modeler 106) include multiple stages of data processing and computation. At the outset, the assistant executed on the user device 120 can receive user provided input, which could be in the form of spoken words, typed text, or a command. This input can be processed by the interface system 104 to be in a format that the policy network can understand.

For example, if the input is spoken, the interface system 104 can perform a speech recognition process where the audio is converted into text. Once the input is in text form, the policy network executed by the modeler 106 can interpret the meaning and context of the words. Specifically, the policy network can use its training on the vast amounts of text data, specifically engagement data 112, to understand language nuances, intentions, and subtleties like sarcasm or urgency. When the model receives input text, it processes this text through its network, applying these learned patterns to generate an appropriate response or action. Once the policy network, executed by the processing circuit of data processing system 102, has processed the input and determined the best personalize response, this response can then be conveyed back to the user through the personalized GUI provided by the interface system 104. If the interaction mode is text-based, the response can be displayed directly on the user device 120. If the interaction is through speech, the text response can be converted into speech using a text-to-speech technology, and then relayed to the user device 120.

In general, storage 110 serves as a repository for various types of data and models used in the functions and executions of the data processing system 102. For example, the storage 110 could be, but is not limited to, solid-state drives (SSDs), hard disk drives (HDDs), cloud-based storage solutions, or distributed data storage systems. In some embodiments, storage 110 can be an internal component within data processing system 102. Alternatively or in combination, storage 110 could be external, such as a separate storage server, connected via interfaces (e.g., SATA or Ethernet). In some embodiments, storage 110 can be distributed, like in cloud storage or network-attached storage systems. Additionally, storage 110 can include a processing circuit for managing data operations, enhancing performance and security in data handling.

The data processing system 102 can communicate with the storage 110 by means of high-speed data buses, network connections, wireless communication protocols, or direct integrated system links. In some embodiments, the efficiency and speed of data retrieval and storage are optimized to ensure real-time processing capabilities. As shown, storage 110 can include engagement data 112 and models 118. The engagement data 112 can include user-specific engagement data 114 and population engagement data 116. In some embodiments, the engagement data 112 can be acquired, received, or collected by the data processing system 102 and stored in engagement data 112. This can include real-time collection of user interactions and behaviors, as well as periodic updates from external data sources. In some embodiments, the interface system 104 can process engagement data 112 received, for example, through the conversational interface. For example, this processing might include analyzing user queries and responses to tailor the system's future interactions. In another example, the data could be used for broader analytical purposes, such as identifying trends and patterns in user engagement across different demographics.

In some embodiments, the modeler 106 can create and generate models, such as the personalized policy networks (or personalization policy networks) described herein. Additionally, other models used in interacting with and engaging the user can be created and stored in models 118. These models 118 are used to provide tailored and effective user interactions. For example, a multilayer perceptron neural network, language models, and predictive analytics models, among others, can be stored in models 118. These models could include algorithms for understanding and processing natural language, predictive models for anticipating user needs or preferences, and analytical models for extracting insights from large datasets.

The user-specific engagement data 114 (shown as “user-specific 114” in FIG. 1) can be individual user data for each person, including their user profile, engagement history, and conversation context. Each individual user can have their unique dataset within the user-specific engagement data 114, reflecting their specific interactions, preferences, and behavioral patterns. In some embodiments, the user-specific engagement data 114 is used to train and create personalized policy networks unique to a particular user or customer. The population engagement data 116 (shown as “population 116” in FIG. 1) can be engagement data from the entire user population. In some embodiments, the population engagement data 116 can be used by the modeler 106 to train a language model to handle general conversational abilities and common interaction patterns shared by all users. Training a shared language model on the aggregated population data can enable the data processing system 102 to efficiently learn this general knowledge. In some embodiments, this aggregated data is utilized to establish baseline models which can serve as the foundational layer for more personalized user interactions. In particular, the baseline models can provide a general understanding of language and user interaction patterns, which can be further refined on an individual level using the user-specific engagement data 114.

In some embodiments, the user device 120 can be configured to interact with the data processing system 102. The user device 120 can be used to record engagement data, for example, from candidate responses provided by interface system 104 of data processing system 102. The user device 120 can be, but is not limited to, smartphones, tablets, laptops, desktop computers, wearable devices, AR/VR/MR devices, talking kiosks, devices with digital assistants, and/or smart home devices, among other devices. The user device 120 can include a processing circuit that manages the interface and data exchange with data processing system 102. In some embodiments, the user device 120 can include a viewport that can present content to the user. The content can be interactable such that users can provide feedback directly through touch gestures, clicks, and/or voice commands. For example, candidate responses, generated by the policy network, can be displayed side-by-side in the viewport of the user device 120 for the user to evaluate. A personalized GUI can elicit explicit engagement signals from the user for each candidate response.

Referring now to FIG. 2, a block diagram depicting a hierarchical personalized policy network and architecture 200, in accordance with some embodiments of the present disclosure. To employ personalization, the hierarchical personalized policy network and architecture 200 can be implemented. The modeler 106 of data processing system 102 can be configured to perform and implement the hierarchical personalized policy network and architecture 200. In some embodiments, the hierarchical personalized policy network and architecture 200 can include two components.

The first component can be a base language model (LM) policy network 216 (shown as base language model (LM) 216 in FIG. 2, sometimes referred to herein as a “base policy network”) trained on engagement data from the entire user population (e.g., stored in population engagement data 116 of storage 110 of FIG. 1). The base LM 216 can receive conversation histories 212 of the entire user population and in turn, provide general conversational abilities and common interaction patterns shared by all users. Training the shared base LM 216 on the aggregated population data can enable efficiently learning of general knowledge.

The second component can be a personalized network 210 (e.g., personalized policy network) that can receive, as input, individual user data for each user, including, but not limited to, their user profile, engagement history, and conversation context (e.g., shown as data 202 and 206, or 1 through n number of user features to train on). As shown, encoder 204 and encoder 208 (e.g., 1 through n number of encoders based on 1 through n number of user feature inputs), executed by modeler 106 can be configured to encode data 202 and 206, respectively, into vector representations summarizing the relevant information. In some embodiments, the vector representations can be encoded using various machine learning models. For example, the encoders 204 and 208 can use recurrent neural networks (RNN) over the engagement history and attention mechanisms over profile and context features to highlight the most relevant features for the current interaction. The encoded user representations can be inputted into to the personalized policy network 210. Generally, the personalized policy network, trained by modeler 106, can utilize a multilayer perceptron (MLP) network. The MLP network can be composed of multiple layers of perceptron (e.g., nodes) that can learn non-linear decision boundaries. Specifically, the personalized policy network using the MLP network can generate a set of Low-Rank Adaptation (LoRA) parameter weights specialized for that user. The LoRA weights can then be applied on top of the base LM policy network 216 to tune its activations to generate a personalized response style catered to that particular individual. It should be understood that other techniques or implementations may be used in place of or alongside MLP networks, such as transformer architectures, Convolutional Neural Networks (CNNs), Recurrent Neural Networks (RNNs) and their variants like LSTM (Long Short-Term Memory) and GRU (Gated Recurrent Units), and Graph Neural Networks (GNNs). These alternatives might provide different advantages in terms of scalability, accuracy, and the ability to capture nuanced aspects of user engagement.

Furthermore, the MLP network can be used by the personalized network 210 to generate a set of LoRA parameter weights. In particular, LoRA can be used to adapt large pre-trained models (like language models) by adjusting only a small subset of their parameters, thus maintaining the general capabilities of the model while customizing it for specific tasks or users. In some embodiments, the LoRA weights are unique to each user and are applied to the base Language Model (LM) policy network 216. The application of these weights, stored in weights 214, can fine-tune certain activations within the base LM 216 (e.g., base policy network), effectively altering its behavior to generate responses that are more aligned with the user's individual characteristics and preferences.

Accordingly, the modeler 106, during training of the personalized policy network 210, can integrate an MLP within its structure. The MLP is a neural network that can consist of at least three layers: an input layer, hidden layers, and an output layer. Each layer can be made up of nodes, or neurons, which are connected by weights. The MLP can take in vector representations of user data (e.g., from encoders 204 and 208) and learns to map this data to outputs (in this case, the LoRA parameters) through a process of optimization during training. That is, the LoRA technique refers to a parameter-efficient method of adapting large, pre-trained language models (e.g., base LM 216). In some embodiments, the modeler 106, using LoRA, can introduce low-rank matrices that modify the weight matrices (e.g., weights 214) of the pre-trained model. Instead of fine-tuning all parameters of the large model (which can be in the billions for modern language models), the modeler 106 can strategically update a smaller subset of parameters. Thus, it should be understood that the personalized policy network 210 is a higher-level framework that employs the MLP to generate LoRA parameters, which are then used to adapt the underlying language model. When a user interacts with the system, their data (e.g., 202 and 206) is first encoded into a vector representation (e.g., by encoders 204 and 208), which is then passed through the MLP. The MLP outputs LoRA parameters tailored to that user, and these parameters are applied to the pre-trained language model to adjust its activations (e.g., its internal state) to produce personalized responses.

In some embodiments, the adapted language model (e.g., base LM 216 with introduced weights 214 based on the personalized network 210) then generates one or more candidate responses 218 that are more aligned with the individual user's characteristics. Various sampling techniques can be used to generate the candidates. In some embodiments, the sampling techniques can include, but are not limited to, temperature sampling, nucleus sampling, beam Search, pure sampling, top-k sampling, among other sampling techniques. Thus, the pre-trained language model using the personalized policy network leverages various sampling techniques to balance the creativity and relevance of the responses. The choice of a sampling method can be tuned to the user's interaction style-promoting either more inventive or more predictable responses-thus optimizing the engagement level of the conversation according to individual user interests and the specific context of the interaction. Accordingly, the personalized policy network is a type of machine learning model designed to operate on top of a pre-trained language model (e.g., base LM 216) to provide personalized interactions.

Referring to how the personalized policy network and the base language model connected in a joint training framework (e.g., the hierarchical personalized policy network and architecture 200). Within this adaptive AI system, the personalized network 210 is trained in tandem with a base LM 216 (e.g., base policy network) using Proximal Policy Optimization (PPO), a strategy within the reinforcement learning domain. The personalized network 210 (sometimes referred to as the “personalized policy network), which is equipped with a multilayer perceptron (MLP), utilizes engagement signals from user interactions as a form of human feedback to guide its learning process. Positive engagement, indicated by user interactions such as continued conversation, delivers a reward signal that is used to refine the network's performance. This reward signal will inform the MLP within the personalized network 210 to produce specific Low-Rank Adaptation (LoRA) weights (e.g., weights 214). These LoRA weights are then applied to the base LM 216 to personalize its responses according to the individual's interaction patterns. As the MLP network generates these LoRA weights and integrates them, the base LM 216, influenced by the personalized network 210, is improved at generating responses that are likely to increase user engagement. Thus, the personalized network 210, through its MLP component and the LoRA weights it generates, shapes the behavior of the base LM 216 to create a more tailored conversational experience for each user.

Additionally, the hierarchical personalized policy network and architecture 200 can further integrate a Neural Hawkes Process (NHP) to model time-dependent interests. In some embodiments, the personalized network 210, enhanced by the MLP and informed by PPO, that creates a responsive architecture that can adapt the base LM 216 to user-specific characteristics through the application of Low-Rank Adaptation (LoRA) weights 214, can be further enhanced by incorporating an NHP statistical model. That is, since interests and engagement are not static, they can follow a time-sensitive pattern where recent events or topics may trigger a heightened level of interaction that gradually diminishes. The NHP statistical model can allow the modeler 106 to capture this ebb and flow by treating user behaviors, such as clicks, swipes, or the lack thereof, as part of an event stream. These event streams can be analyzed by the NHP statistical model to understand the latent temporal dynamics.

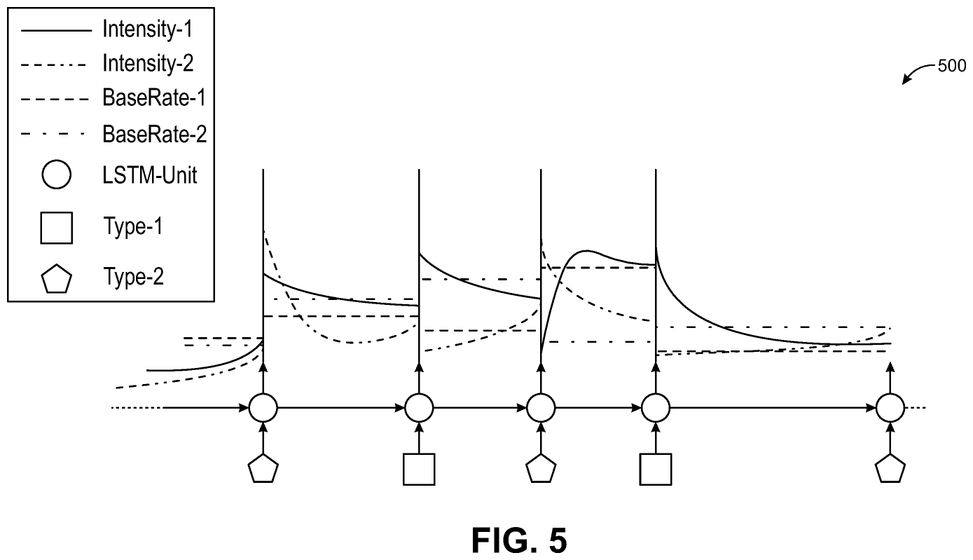

By incorporating one or more NHP statistical models into the personalized network 210, the personalized network 210 can utilize the temporal insights provided by these processes to adjust the LoRA weights in the MLP network more precisely over time. This ensures that the base LM 216 provides personalized content and content that is temporally relevant, addressing the current interests of the user and anticipating the natural progression of their engagement. Furthermore, the NHP, as a statistical model, analyzes user interaction data over time, providing insights into how user interests and engagement levels evolve. This temporal understanding is fed into the personalized network 210, which utilizes the MLP to process these insights and generate LoRA weights accordingly. These weights 214 are then applied to the base LM 216 to adjust its responses. Simultaneously, Proximal Policy Optimization (PPO) is employed to fine-tune the policy networks (e.g., base LM policy network 216 and personalized policy network 210), ensuring that the updates influenced by the NHP align with the overall goal of maximizing user engagement. The modeling of time-dependent interests is described in greater detail with reference to FIG. 5.

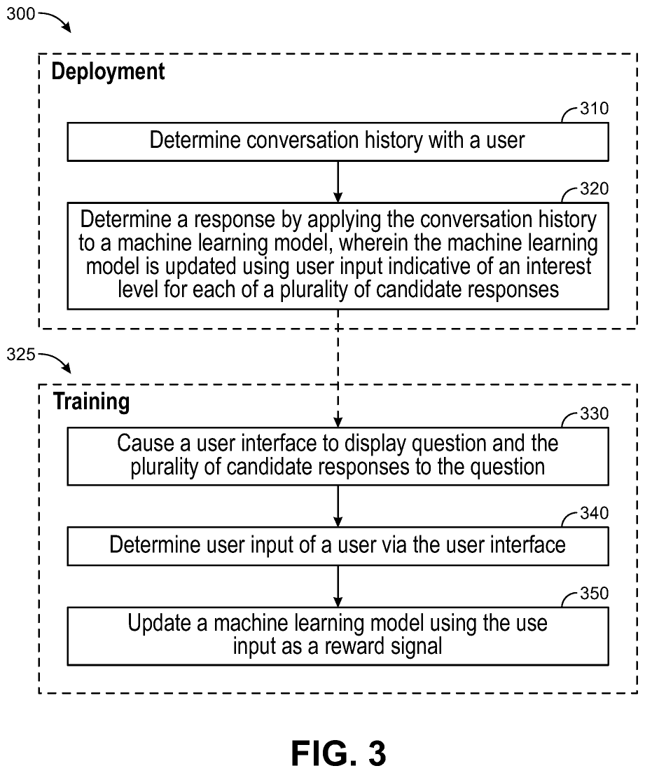

Referring now to FIG. 3, a flow diagram of an example of a method for personalizing and training a conversational agent and improving user engagement, in accordance with some embodiments of the present disclosure.

At block 300, the execution or deployment of the models can be performed by the processing circuits. The data processing system 102 can be configured to perform method 310-320. Further, any computing device described herein can be configured to perform method 310-320. Additional, fewer, or different operations may be performed depending on the particular arrangement. In some embodiments, some, or all operations of method 310-320 may be performed by one or more processors executing on one or more computing devices, systems, or servers. In various embodiments, each operation may be re-ordered, added, removed, or repeated.

At block 310, the processing circuits can determine first conversation history with a user. This first conversation history captures the current or new interaction between the user and the interactive interface, serving as a dataset for the user's initial engagement. It provides immediate the processing circuits insights into the user's current interests and preferences, helping to shape the initial responses of the processing circuits in a way that is relevant and engaging for the user at that specific moment.

At block 320, the processing circuits determine a response by applying the first conversation history with the user to a machine learning model, wherein the machine learning model is updated using user input indicative of an interest level of the user for each of a plurality of candidate responses to a question, a content of the question is determined by the at least one processor, and the plurality of candidate responses are determined by the machine learning model, and the machine learning model is updated using the user input as a reward signal. In some embodiments, the machine learning model is a composite system integrating a base language model with the personalized policy network. This integration allows for the effective synthesis of user-specific data and general language understanding. Additionally, updating the machine learning model using the user input as a reward signal includes analyzing user responses to adjust the LoRA weights within the MLP, thereby fine-tuning the policy network to enhance personalization and relevance. In this process, the Neural Hawkes Process (NHP) is employed by the processing circuit to analyze the temporal dynamics of user engagement. The personalized policy network, incorporating the MLP and generating LoRA weights, adapts the base language model's output to align with the user's specific interaction style and preferences. Proximal Policy Optimization (PPO) is utilized to optimize the policy network's performance based on engagement metrics, ensuring that the responses are not only relevant but also timely and engaging. This holistic approach ensures that the system remains adaptive and responsive to the nuanced changes in user behavior and preferences over time. Following this, the processing circuits continue to refine the machine learning model by integrating real-time user feedback and the temporal insights provided by the NHP.

In some embodiments, to determine the plurality of candidate responses using second conversation history with the user and user data of the user, the processing circuits can use the user's past interactions with the interactive interface. This second conversation history provides a broader context, encompassing previous engagements and revealing how the user's interests and responses have evolved over time. The user data, which may include other user-specific engagement data such as click patterns, time spent on various topics, and feedback given. In guiding the machine learning model, particularly in the generation of candidate responses and updating the model's parameters, this second conversation history and user data are used. Thus, the second conversation history influences the adjustment of the LoRA weights within the personalized policy network.

In some embodiments, the user input includes a first user input indicating positive interest and a second user input indicating negative interest. These inputs are used to calibrate the machine learning model, particularly in adjusting the LoRA weights within the personalized policy network. Positive inputs lead to reinforcement of similar response patterns, while negative inputs guide the model to alter its approach. In some embodiments, the processing circuits can update the base policy network using a reward function, which is used for fine-tuning the network's responses. This is achieved by applying the user input as the reward signal to the reward function. Consequently, updating the machine learning model includes maximizing an expected reward for the base policy network, aligning its outputs with user preferences as indicated by their input.

At block 325, the training of the models can be performed by the processing circuits. In general, block 325 can be performed before, during, or after blocks of block 300. The data processing system 102 can be configured to perform method 330-350. Further, any computing device described herein can be configured to perform method 330-350. In some embodiments, some, or all operations of method 330-350 may be performed by one or more processors executing on one or more computing devices, systems, or servers. In various embodiments, each operation may be re-ordered, added, removed, or repeated.

At block 330, the processing circuits can cause a user interface to display a question and a plurality of candidate responses to the question, wherein a content of the question is determined by the at least one processor. In some embodiments, the user interface is a personalized GUI provided and presented in a viewport of a user device. The candidate response can be generated by the processing circuit executing the policy network. Each candidate response generated by the policy network can represent an action. The content of the candidate response can include various application specific information. For example, for a social companion chatbot application, the processing circuits can provide user-specific content related to recommendations with travel, books, cooking, etc. In another example, for a sales assistant application, the processing circuits can provide user-specific content related to clothing sold by a particular platform or company. In yet another example, for a tutoring system application, the processing circuits can provide user-specific content related various educational subjects. Generally, the candidate responses attempt to separate preferences of the user with interests of the user. Specifically, in typical language models, preferences of the user are collected offline with labels being applied to preferred responses. Instead of typical language models, the processing circuits described herein can cause a user interface to have a continuous flow of lively generated content that allows the user to select and provide input regarding their current interest or interests, not simply their existing preferences.

In some embodiments, the interface record can include binary engagement data for each candidate response, indicating whether the user chose to engage that option. The conversational interface can be implemented as a web or mobile application that enables the assistant to initiate dialog instead of passively responding. Multiple candidate responses can be generated by the policy network and displayed side-by-side for the user to evaluate. Specifically, the user interface can elicit explicit engagement signals from the user for each candidate response. For example, two to four candidate responses can be retrieved from the policy network based on the conversation history and context. These candidates can be displayed simultaneously to the user. In this example, the user can choose to swipe away responses that they find uninteresting or undesirable, essentially ignoring them. If a response intrigues the user, they tap on it to engage and continue the conversation in that direction. Accordingly, this interaction mechanism provides a clear binary engagement signal per candidate, indicating whether the user wanted to engage that response option. The interface records the engagement data for all displayed candidates. The policy network is then updated based on this engagement feedback to maximize future engagement. In some embodiments, displaying multiple candidates side-by-side can encourage comparative evaluation by the user. It also enables the efficient collection of engagement signals on multiple responses in parallel during normal conversation. Explicit engagement actions like swiping and tapping provide clearer feedback signals compared to passive listening.

At block 340, the processing circuits can determine user input of a user via the user interface, the user input indicative of an interest level of the user for each of the plurality of candidate responses. This input can provide feedback on the user's engagement with each response, allowing the processing circuits to gauge which responses are more effective or appealing. The user's interactions, whether they are clicks, swipes, or other forms of engagement, are captured and analyzed to understand preferences and interest levels. This data then informs the subsequent stages of processing, shaping the training and refinement of the machine learning models involved.

At block 350, training of the model can occur by updating, by the processing circuits, a machine learning model using the user input as a reward signal. This training incorporates the Neural Hawkes Process (NHP) to analyze temporal dynamics in user engagement, thereby enhancing the personalized policy network's ability to adapt responses over time. The MLP network within the personalized policy network generates LoRA weights, influenced by both the NHP analysis and user feedback. These weights are then applied to the base LM, allowing it to produce responses that are not only personalized but also temporally relevant. Proximal Policy Optimization (PPO) is also employed throughout this process to optimize the policy network's performance, ensuring that the updates driven by the NHP and user engagement improve the model's ability to interact with users in a dynamically engaging manner.

Furthermore, multiple value models can be trained by collecting explicit user engagement data for each candidate response from the conversational interface, with the Neural Hawkes Process (NHP) analyzing the temporal aspects of this engagement. The engagement signals serve as a reward for training the personalized policy network using a Reinforcement Learning from Human Feedback (RLHF) approach. The processing circuits employ Proximal Policy Optimization (PPO) with an engagement-oriented reward function, integrating the insights from the NHP. Each candidate response generated by the personalized policy network, using the MLP network to produce LoRA weights, represents an action. A reward of +1 can be provided for responses that engage the user, indicating their interest and willingness to continue the conversation, while responses that are ignored may receive a 0 reward. The reward signal, enhanced by the temporal understanding from the NHP, is used to maximize the expected engagement reward over time by updating the policy network and the base LM.

In some embodiments, a PPO loss function, incorporating feedback from the NHP, acts as a KL divergence penalty term between the updated policy network and the original policy network. This function serves as a regularization mechanism to prevent the policy network, enhanced with LoRA weights from the MLP network, from deviating too far from its original behavior. Without this constraint, the policy network might exploit flaws in the limited engagement data. In addition to the engagement reward, the processing circuit can include other RLHF preference rewards based on human ratings or rankings of response quality. Thus, the reward signal combines engagement optimization, informed by the NHP, with the generation of high-quality responses.

In certain embodiments, when using both ratings and rankings with the engagement reward, the processing circuit can give more weight to the engagement reward. This approach ensures that user interactions, analyzed through the NHP, have a stronger influence on the learning and adaptation of the personalized policy network. The balance between user engagement and quality ratings, dynamically adjusted with insights from the NHP and LoRA weights, can be tailored based on specific application requirements or desired outcomes, allowing the personalized policy network to offer varying user expectations and application contexts. Specifically, the personalized policy network includes the integrated components of the MLP network and the application of LoRA weights, and is informed by insights from the Neural Hawkes Process (NHP). The personalized policy network works in conjunction with the base LM and employs PPO in its training and adaptation processes. The modeling of time-dependent interests is described in greater detail with reference to FIG. 5.

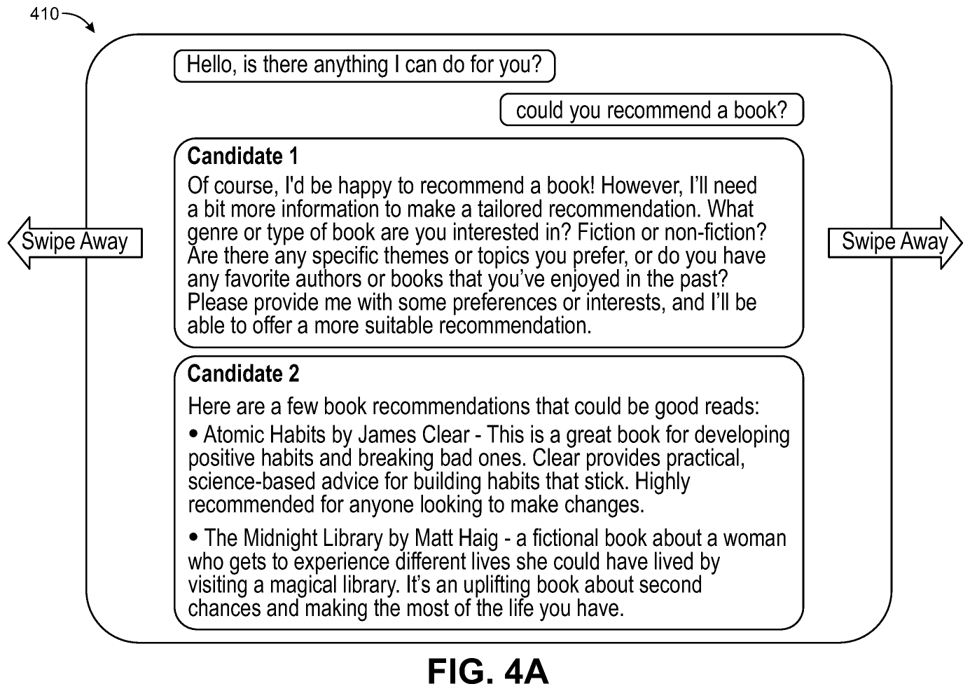

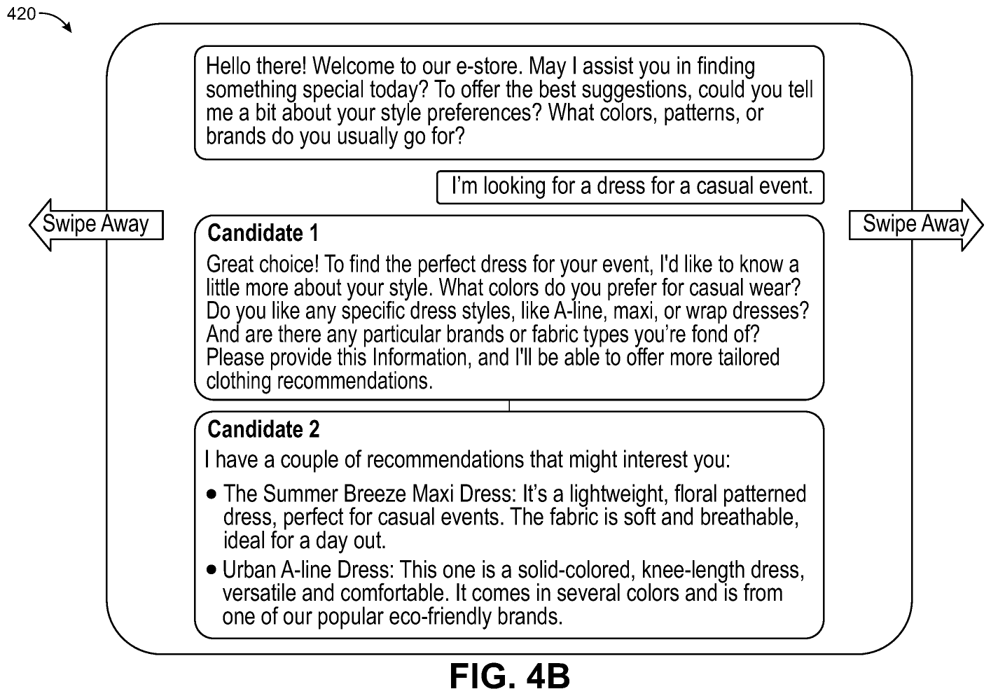

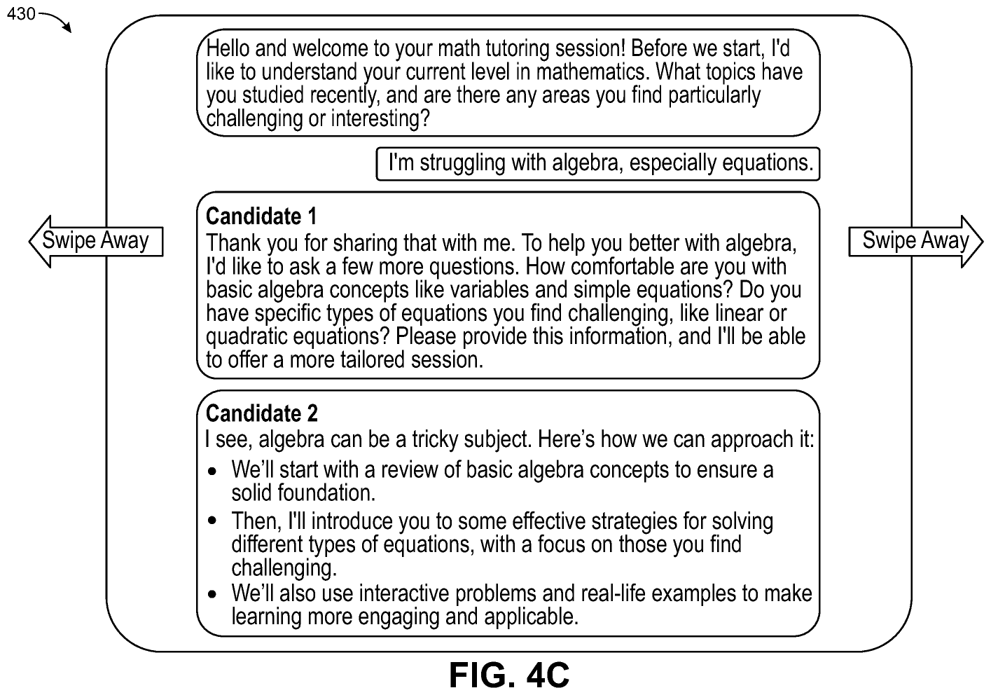

Referring now to FIGS. 4A-4C, depicting example conversations with the personalized conversation agent described in FIGS. 1-3, in accordance with some embodiments of the present disclosure. In some embodiments, the personalized GUIs 410, 420, and 430 can be presented within a viewport (e.g., display, screen, or virtual interface) of a user device 120. As shown, the personalized GUIs 410, 420, and 430 can provide multiple responses (e.g., Candidate 1 and Candidate 2), where the user can select which response they desire to engage. Additionally, if none of the responses satisfy the user, the user can “swipe away” the responses by completing a gesture-based command, such as a horizontal swipe motion on a touch-sensitive screen of their user device 120, or by clicking and dragging with a mouse on a non-touch interface. In some embodiments, the user selection of the response they desire to engage can continue the conversation based on the selection. Accordingly, in some embodiments, when the assistant provides a response, it can provide responses with multiple choices of responses for the user to select or “swipe away” (e.g., providing a signal to the data processing system 102 about what the user is interested in). While various implementations are described with reference to personalized GUIs 410, 420, and 430, it should be understood that these are merely exemplary and that the concepts and functionalities can be applied to a wide range of other interfaces and systems. The principles and features discussed can be adapted to different formats, platforms, and technologies, offering flexibility in application and design to meet diverse user needs and technological environments.

In personalized GUI 410, the assistant could be implemented as a social companion chatbot. In some embodiments, the social companion chatbots can be trained to build emotional connections and have engaging conversations with users. The conversational interface provided to the user device 120 can elicit explicit user engagement data to optimize the policy network. This can help drive conversations that interest and intrigue users, encouraging them to keep chatting. As such, the personalization based on the user's profile and conversation history adapts the dialog style to each individual. In particular, the personalized GUI 410 can proactively guide conversations based on user interests instead of passively responding. For example, the assistant can initiate new topics and make intriguing conversation moves tailored to the user. Additionally, the personalized GUI 410 can provide mixed-initiative dialog where both the user and assistant drive the conversation (e.g., the assistant does not need to be prompted with commands). Furthermore, the personalized GUI 410, implemented by the policy network trained and re-trained by modeler 106 of FIG. 1, can memorize and maintain consistency in dialog behavior from conversation to conversation. For example, the personalized GUI 410 can provide humor, wit, and variability based on user preferences, avoiding repetitive responses. Accordingly, the policy network can perform gradual learning over time to improve personalization to the user as more data is collected. This can help create rapport between the user and assistant and allows the conversations in the personalized GUI 410 to feel more natural, reducing the sensation of talking to an AI system, which in turn can maximize engagement, encouraging users to have extended chats with the assistant like a friend.

In personalized GUI 420, the assistant could be implemented as a sales assistant. For example, a clothing e-retailer could use the policy network of data processing system 102 as a conversational agent to assist customers in selecting products on its website. The virtual sales assistant could initiate natural dialog with shoppers by asking questions to gather details about their preferences. For example, it may inquire about favored colors, patterns, brands, and other stylistic inclinations to construct a profile of the customer's tastes. As the user browses the product catalog, the conversational agent could draw on this preference profile to proactively put forth personalized recommendations aimed at aligning with the individual's style. The personalized GUI 420, implemented by the policy network trained and re-trained by modeler 106 of FIG. 1, can attempt to sustain engagement throughout the shopping experience to foster rapport resembling human-to-human interaction. To this end, the policy network can be trained to employ conversational tactics to re-engage users if they appear dissatisfied or disengaged. Thus, the assistant's responses on the personalized GUI 420 are powered by a personalized policy network that encodes the specific customer's past engagement patterns to optimize future engagement. Furthermore, on the backend, the modeler 106 can maintain customer profiles encapsulating full historical interaction data including engagement metrics, purchases, and other inferred preferences. For returning customers, the assistant could leverage this information repository to deliver highly tailored service, such as addressing them by name or referencing their prior shopping history. Accordingly, the personalized policy network molds assistant responses to align with previously successful engagement strategies for each individual. Specifically, the virtual sales assistant can provide an intelligent and enjoyable shopping experience by emulating human rapport-building and recommendation strategies. That is, often optimizing engagement and personalization are key to engendering customer satisfaction and driving sales volume by connecting shoppers with products catered to their unique tastes. Thus, the humanesque conversing and personalization provided in personalized GUI 420 can help build lasting emotional bonds between customers and the retailer's brand.

In personalized GUI 430, the assistant could be implemented as a tutoring system. For example, a middle school student could interact with the tutoring system to learn mathematics. In this example, the virtual assistant tutor could initiate the instructional dialog by asking questions to gauge the student's existing math knowledge. The policy network could then adjust its teaching style and lesson pacing to match the individual's abilities, accelerating for advanced students or taking a more measured approach for those needing more foundational support. Throughout the tutoring sessions, the virtual assistant tutor could sustain engagement by monitoring the student's level of interest and motivation. If the student appears distracted or frustrated, the assistant could attempt different pedagogical tactics to re-engage them with the material. Specifically, the personalized policy network would draw on previously successful engagement strategies for each specific student. Furthermore, on the backend, the modeler 106 can maintain learner profiles, tracking factors like knowledge gaps, engagement patterns, and lesson performance history. For recurring students, the assistant would leverage this information to deliver personalized tutoring catered to the individual's learning needs. For example, the assistant may reference past difficulty with certain math topics when introducing related new concepts. Thus, by optimizing pedagogical strategies for engagement and personalization, the personalized GUI 430 can provide an enjoyable, tailored learning experience that keeps students motivated. The human-like conversing can help build rapport between the learner and tutor.

Referring now to FIG. 5, a depiction of an example event stream 500 related to user interest and engagement, in accordance with some embodiments of the present disclosure. User interests and engagement often exhibit time-decaying behavior, where the relevance of a topic or response type decays over time. For example, a user may be highly engaged with discussing a recent movie when it is new, but that interest fades after some weeks. To account for this temporal effect, the personalized policy network (described in detail with reference to FIGS. 1-2) can model the engagement reward using a Neural Hawkes Process (NHP). In general, the modeler 106 of data processing system 102 can collect users' behaviors of clicking or not (e.g., click=yes, no click or sliding away=no) and model these as event streams 500 in an NHP. Specifically, NHPs are stochastic point processes with latent temporal dynamics that can capture the spikes and decays in engagement over time.

As shown, the modeler 106, implementing the LSTM (or any recurrent networks), can read the sequence of past events (polygons such as Type-1 and Type-2, events correspond to a user's click log or sliding behavior record) to arrive at a hidden state (circle, LSTM-Unit). That state determines the future (probability) “intensities” of the two types of events (event sets)—that is, their time-varying instantaneous probabilities. The intensity functions are continuous parametric curves (Intensity-1 and Intensity-2) determined by the most recent state (e.g., LSTM state), with base rates (BaseRate-1 and BaseRate-2) and showing the steady-state asymptotes that they would eventually approach. In this example, events of type 1 excite type 1 but inhibit type 2 (e.g., preferring one type implicitly show the user's disliking of another type). Type 2 excites itself, and excites or inhibits type 1 according to whether the count of type 2 events so far is odd or even. Those are immediate effects, shown by the sudden jumps in intensity. The events also have longer-timescale effects, shown by the shifts in the asymptotic dashed lines. In some embodiments, as the LSTM processes event types, such as clicks and swipes, it dynamically adjusts its hidden state to reflect the immediate and long-term implications of these interactions. The LSTM can be used by the modeler 106 to capture and project the intensity of user interactions over time feeds into the personalized policy network, enabling it to adjust the LoRA weights in a way that optimizes the base language model's output for each individual user.

The NHP is a mathematical stochastic process with self-exciting and mutually exciting mechanisms. One event, or an event category, can be influenced by historical events and further excites or inhibits future event streams. In order to predict which events are most likely to happen next and the time they will happen, the modeler 106 can learn the distribution of the sequences of the events in and among related target domains. For example, one model for modeling these event streams is the Poisson process, which employs an intensity parameter λ to describe the instantaneous probabilities of the target events, supposing that no memory information is utilized. By extending this process to letting λ vary according to time t, non-homogenous Poisson process can be provided. Precisely, an event of type k occurs at time t in the infinitesimally wide interval [t, t+dt] with an instantaneous probability of λₖ(t)dt. A NHP further append three assumptions to this process, supposing that historical events can temporarily bring excitations to future events, in which the excitations are (1) positive, (2) additive over the past events, and (3) exponentially decaying with time:

$${λ}_{k} ( t ) = {μ}_{k} + {\sum }_{h : {t}_{k} < t} {α}_{{k}_{h} , k} exp ( - {δ}_{{k}_{h} , t} ( t - {t}_{h} ) )$$

where μₖ≥0 is the base intensity of event type k, α_{j,k}≥0 is the degree to which an event of type j initially excites type k, and δ_{j,k}≥0 is the decay rate of that excitation, where λₖ is the engagement score and μₖ is the mean engagement score, where αₖ_{ₕ}_{,k} is the parameter to define the interaction between the event and the user (e.g., some news or topic may be extremely sensitive to the user), where t is the current time.

In a neural NHP, μₖ and α are respectively extended to include negative values for the inherent inertia cases (e.g., some events are unlikely to happen until their cumulative excitation by past events crosses some threshold) and inhibition effects between event types (e.g., buying one brand's product likely prevents from buying other brands and vice versa). Also, since the LM response space is infinitely large, the category of event type k is implicit in the text which can be encoded as text embeddings. For simplicity, k can be used to denote different types in the following text. Thus, a continuous-time LSTM (or, any recurrent network, or a self-attention network) can be used to learn a latent dependency of the intensities on the number, type, and timing of past events. In the continuous interval following an event, such as t∈(tᵢ₋₁, tᵢ), each element in the memory cell c exponentially decays at some different rate δ towards some steady-state value c.

Furthermore, c (t) is then used to control the hidden states h (t) with D dimensions which finally determines the event type sensitive intensity function λₖ(t):

$$engagement score = {λ}_{k} ( t ) = {f}_{k} ( {w}_{k}^{T} h ( t ) )$$

$$h ( t ) = {o}_{i} tanh ⊙ ( c ( t ) ) , t ∈ ( {t}_{i - 1} , {t}_{i} )$$

where wₖ^{T} is a learnable vector, fₖ(x)=sₖ log (1+exp (x/sₖ)) is a softplus function (with learnable parameter sₖ which approaches ReLU as sₖ→0 to ensure that the intensities to be positive, oᵢ is the vector from the output gate of the continuous-time LSTM, ⊙ stands for the point-wise production, and tanh projects c(t) into a (−1,1)^{D} range vector to align with inertia.

The NHP intensity function modulates the engagement reward R_{eng}: R(t)=R_{eng}λₖ(t). This time-sensitive reward reflects the user's current interests and drives the assistant to engage those topics (k, such as a particular movie, book, travel destination). Additionally, time t can be a real-time stamp. For example, in group-chat oriented dialog system, the following sequence can be modeled: <user, topic, engagement score, time>. As interests decay, old responses get less reward. On the other hand, if the recent series of events excites the current event, the reward is boosted up higher. For example, if the user is engaged in a few conversations on one topic, the same topic candidate is likely to have an increased engagement reward.

In some embodiments, the NHP implemented by modeler 106 can provide various improvements to existing modeling. First, a time decay function (learnable) is used to better express the real-world style decaying of one topic to one user and better express the whole lifecycle with a sequence of self-exciting time-sensitive events. Second, the NHP is a better expression of self-exciting and manual inhibiting of between or among several types of topics so that the engagement rate of a list of candidate topics can be modeled by fitting better to the real-world applications. Lastly, the NHP is a proactive approach of predicting the next time point that a user may be interested in a special topic so that the conversational agent is able to recommend the related topics in a proactive manner to improve the final engagement time of between the user and the recommended topic and between the user and the conversational agent.

Accordingly, the implementation of the NHP within the personalized policy network brings improvements to the overall system's responsiveness and relevance. By utilizing the NHP's capabilities to understand and model the temporal dynamics of user engagement, the system can more accurately predict shifts in user interests and adjust its responses accordingly. The integration of the NHP with the MLP network and the application of LoRA weights within the personalized policy network allows for a refined adaptation of the base language model's outputs. This adaptation is not static but evolves in real-time, responding to the immediate and changing interests of the user as captured by the NHP's analysis. Furthermore, the use of Proximal Policy Optimization (PPO) in this framework ensures that the updates and adaptations made to the policy networks, both the base LM and the personalized policy network, are optimized towards increasing user engagement.

### Example Content Streaming System

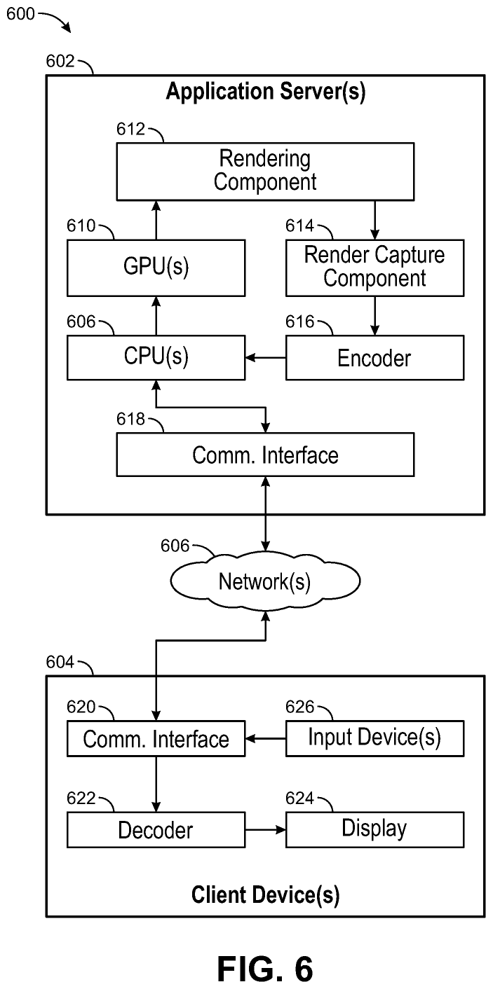

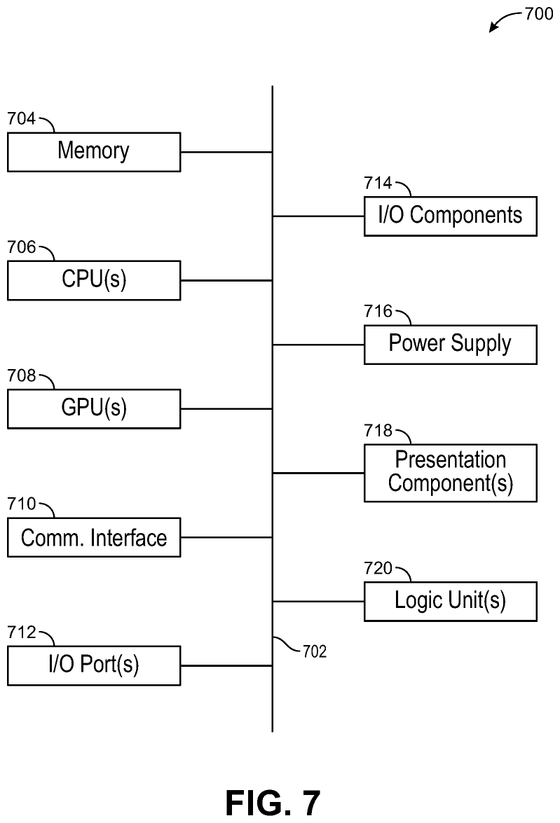

Now referring to FIG. 6, is an example system diagram for a content streaming system 600, in accordance with some embodiments of the present disclosure. FIG. 6 includes application server(s) 602 (which may include similar components, features, and/or functionality to the example computing device 700 of FIG. 7), client device(s) 604 (which may include similar components, features, and/or functionality to the example computing device 700 of FIG. 7), and network(s) 606 (which may be similar to the network(s) described herein). In some embodiments of the present disclosure, the system 600 may be implemented to generate tokens to model agent actions and/or update/train or execute machine-learning models to simulate agent actions, as described herein. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 600 can be implemented to receive input indicating one or more features of output to be generated using a neural network model, provide the input to the model to cause the model to generate the output, and use the output for various operations including display or simulation operations.

In the system 600, for an application session, the client device(s) 604 may only receive input data in response to inputs to the input device(s) 626, transmit the input data to the application server(s) 602, receive encoded display data from the application server(s) 602, and display the display data on the display 624. As such, the more computationally intense computing and processing is offloaded to the application server(s) 602 (e.g., rendering—in particular ray or path tracing—for graphical output of the application session is executed by the GPU(s) of the application server(s) 602). In other words, the application session is streamed to the client device(s) 604 from the application server(s) 602, thereby reducing the requirements of the client device(s) 604 for graphics processing and rendering.

For example, with respect to an instantiation of an application session, a client device 604 may be displaying a frame of the application session on the display 624 based at least on receiving the display data from the application server(s) 602. The client device 604 may receive an input to one of the input device(s) 626 and generate input data in response. The client device 604 may transmit the input data to the application server(s) 602 via the communication interface 620 and over the network(s) 606 (e.g., the Internet), and the application server(s) 602 may receive the input data via the communication interface 618. The CPU(s) 608 may receive the input data, process the input data, and transmit data to the GPU(s) 610 that causes the GPU(s) 610 to generate a rendering of the application session. For example, the input data may be representative of a movement of a character of the user in a game session of a game application, firing a weapon, reloading, passing a ball, turning on a vehicle, etc. The rendering component 612 may render the application session (e.g., representative of the result of the input data) and the render capture component 614 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 602. In some embodiments, one or more virtual machines (VMs)—e.g., including one or more virtual components, such as vGPUs, vCPUs, etc.—may be used by the application server(s) 602 to support the application sessions. The encoder 616 may then encode the display data to generate encoded display data and the encoded display data may be transmitted to the client device 604 over the network(s) 606 via the communication interface 618. The client device 604 may receive the encoded display data via the communication interface 620 and the decoder 622 may decode the encoded display data to generate the display data. The client device 604 may then display the display data via the display 624.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may be arranged in various topologies, including but not limited to bus, star, ring, mesh, tree, or hybrid topologies. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU 708 may include its own memory or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, including wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708. In some embodiments, a plurality of computing devices 700 or components thereof, which may be similar or different to one another in various respects, can be communicatively coupled to transmit and receive data for performing various operations described herein, such as to facilitate latency reduction.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

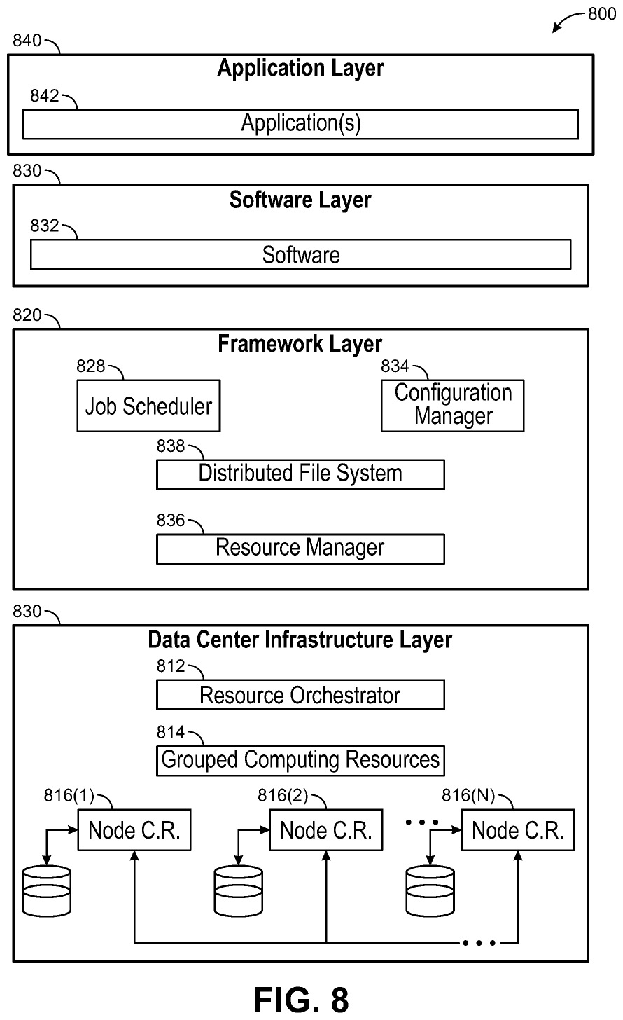

FIG. 8 illustrates an example data center 800 that may be used in at least one embodiments of the present disclosure, such as to implement the systems 100, 200, or in one or more examples of the data center 800. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more embodiments, such as to generate tokens to model agent actions, and/or to update/train transformer models (e.g., the transformer model 118, the transformer model 300) to generate simulated actions for agents in a scene (e.g., the scene 106).

In at least one embodiment, any of configuration manager 834, resource manager 836, and resource orchestrator 812 may implement any number and type of self-modifying actions based at least on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to update/train one or more machine-learning models (e.g., policy networks, etc.) or predict or infer information using one or more machine-learning models according to one or more embodiments described herein. For example, a machine-learning model(s) may be updated/trained by calculating weight parameters according to a neural network architecture using software and/or computing resources described above with respect to the data center 800. In at least one embodiment, trained or deployed machine-learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program including a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, includes multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system including multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising at least one processor to:
determine first conversation history with a user; and
determine a response by applying the first conversation history with the user to a machine learning model, wherein:
the machine learning model is updated using user input indicative of an interest level of the user for each of a plurality of candidate responses to a question;
a content of the question is determined using the at least one processor;
the plurality of candidate responses are determined using the machine learning model; and
the machine learning model is updated using the user input as a reward signal.

2. The system of claim 1, wherein the at least one processor is to determine the plurality of candidate responses using second conversation history with the user and user data corresponding to the user.

3. The system of claim 1, wherein:
the machine learning model comprises an encoder, a base policy network, and a personalization network;
the encoder is to determine at least one vector representation of user data of the user by encoding user data;
the personalization network is to determine at least one weight by inputting the at least one vector representation into the personalization network; and
the at least one weight is applied to the base policy network.

4. The system of claim 3, wherein:
the base policy network and the personalization network are updated using proximal policy optimization to increase the reward signal; and
the machine learning model, using a Neural Hawkes Process (NHP) statistical model, analyzes temporal dynamics in user engagement for the determination of the at least one weight.

5. The system of claim 3, wherein:
the personalization network employs a Multilayer Perceptron (MLP) network to generate a plurality of weights based on user data; and
the plurality of weights are applied to the base policy network to personalize responses.

6. The system of claim 1, wherein the machine learning model is a large language model (LLM), and wherein the machine learning model is updated using reinforcement learning from human feedback (RLHF).

7. The system of claim 1, wherein the at least one processor is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system for hosting one or more real-time streaming applications;
a system for performing light transport simulation;
a system for performing collaborative content creation for 3D assets; or
a system implemented at least partially using cloud computing resources.

8. The system of claim 1, wherein the user input comprises a first user input indicating positive interest and a second user input indicating negative interest.

9. The system of claim 1, wherein:
the machine learning model comprises a base policy network;
the at least one processor updates the base policy network using a reward function;
the at least one processor applies the user input as the reward signal to the reward function; and
the machine learning model is updated by increasing an expected reward for the base policy network.

10. A system comprising at least one processor to:
cause a user interface to display a question and a plurality of candidate responses to the question, wherein a content of the question is determined using the at least one processor;
determine user input of a user via the user interface, the user input indicative of an interest level of the user for each of the plurality of candidate responses; and
update one or more parameters of a machine learning model using the user input as a reward signal.

11. The system of claim 10, wherein the machine learning model determines the plurality of candidate responses using conversation history with the user and user data corresponding to the user.

12. The system of claim 10, wherein the question and the plurality of candidate responses are displayed simultaneously in a same screen of the user interface.

13. The system of claim 10, wherein:
the machine learning model comprises an encoder, a base policy network, and a personalization network;
the encoder is to determine at least one vector representation of user data of the user by encoding the user data;
the personalization network is to determine at least one weight by inputting the at least one vector representation into the personalization network; and
the at least one weight is applied to the base policy network.

14. The system of claim 13, wherein:
the base policy network and the personalization network are updated using proximal policy optimization to maximize the reward signal; and
the machine learning model, using a Neural Hawkes Process (NHP) statistical model, analyzes temporal dynamics in user engagement for the determination of the at least one weight.

15. The system of claim 13, wherein:
the personalization network employs a Multilayer Perceptron (MLP) network to generate a plurality of weights based on user data; and
the plurality of weights are applied to the base policy network to personalize responses.

16. A method, comprising:
determining, using one or more processing circuits, conversation history with a user; and
determining, using the one or more processing circuits, a response by applying the conversation history with the user to a machine learning model, wherein the machine learning model is updated using user input indicative of an interest level of the user for each of a plurality of candidate responses to a question.

17. The method of claim 16, wherein the plurality of candidate responses are determined using second conversation history with the user and user data of the user.

18. The method of claim 16, further comprising:
determining, using the one or more processing circuits, at least one vector representation of user data of the user by encoding user data;
determining, using the one or more processing circuits, at least one weight by inputting the at least one vector representation into a personalization network; and
applying, using the one or more processing circuits, the at least one weight is to a base policy network.

19. The method of claim 18, wherein:
the base policy network and the personalization network are updated using proximal policy optimization to maximize a reward signal; and
the one or more processing circuits executing the machine learning model, using a Neural Hawkes Process (NHP) statistical model, analyzes temporal dynamics in user engagement for the determination of the at least one weight.

20. The method of claim 18, further comprising:
generating, using the one or more processing circuits, a plurality of weights based on user data using a Multilayer Perceptron (MLP) network.
